(19) United States
(12) Patent Application Publication
(10) Pub. No.: US 2006/0028999 A1
(43) Pub. Date: Feb. 9, 2006

(54) Flows based visualization of packet networks with network performance analysis, troubleshooting, optimization and network history backlog

(76) Inventors: Robert Iakobashvili, Ashdod (IL); Hanoch Newman, Tel-Aviv (IL)

Correspondence Address: Robert Iakobashvili, Ha-Atzmaut 12/12, Ashdod, 77452, IL

(21) Appl. No.: 11/237,675

(22) Filed: Sep. 29, 2005

(30) Foreign Application Priority Data
Mar. 28, 2004 (WO) PCT/IL04/00281

(51) Int. Cl. H04J 1/16

(52) U.S. Cl. 370/252; 370/351

(57) ABSTRACT

The present invention is a computer system and a method for gathering, processing and analysis of network information resulting in presentation and visualization of packet networks in the form of individual virtual flows, sometimes also called connections or sessions, containing their statistical characteristics in a time-sampled dynamics. The system, deployed as a separate device or co-hosted with other network devices, collects and processes information from all valid packets in network, classifies and maps gathered statistics to the statistics of relevant virtual flows. The statistical information is further processed by the system to provide near-real presentation, as well as stored in a searchable database for future analyses. The invention to be used by network engineers and administrators as a tool for a near real-time control of network traffic, as an analytical tool for solving network bottlenecks, network performance optimization and troubleshooting analyses, cutting costs by optimizing network layout, appropriate organization of traffic and intelligent configuration of QoS, routers and other network devices.

### TECHNICAL FIELD OF THE INVENTION

The present invention relates generally to computers and packet networks and in particular to network monitoring, gathering of statistical information and using it for network troubleshooting and improvement of networks performance and traffic optimization.

Common Abbreviations:

FTP—file transfer protocol;
GUI—graphical user interface;
IDS—intrusions detection system;
IP—internet protocol;
LAN—local area network;
MAC—medium access control;
NIC—network interface card;
QoS—quality of service;
RTT—round trip time;
SLA—service level agreement;
TCP—transmission control protocol;
UDP—user datagram protocol;
WAN—wide area network;
   Non-Common Abbreviations:
AGVF—aggregate-virtual-flow;
DPVU—data presentation and visualization unit;
DSU—data storage unit;
IPU—information processing unit;
NE—network element.
NIU—network interface unit;
VF—virtual flow;
VFID—virtual flow id;
VSF—virtual super-flow;

### BACKGROUND ART

TCP/IP networks operate with OSI-4 connection-oriented transport protocol TCP/IP and connectionless protocol UDP/IP. The packets running in networks can be logically assembled to so-called streams, also known as sessions or flows, hereafter virtual flows (VFs). Several VFs related to the same application task can be logically combined into virtual super-flow (VSF), e.g. FTP protocol control and data VFs compose an FTP VSF. There is an exact mapping between a VF and a layer-4 connection-oriented protocol session, e.g. TCP-session. The VF is also applicable to sessionless protocols, for example UDP, whereas VF is characterized by a set of parameters, such as source and destination IP-addresses, source and destination ports and IP-protocol (hereafter this set of parameters is called VF-identity parameters, or VFID). For layer-4 session-keeping protocols, e.g. TCP/IP, the virtual flow is started with the first control packet of a session (SYN) and is completed either by a last one (ACK after FIN or RST), or by a sufficiently long configurable timeout. In the case of layer-4 connectionless protocols, e.g. UDP/IP, the virtual flow is started with the first packet having a unique VFID and is completed by a sufficiently long configurable timeout.

Network administrators and engineers have a rather limited set of tools to visualize and control their networks. Their main tools are sniffer/data analyzer type products, which are capable of capturing and presenting packets running in a network, like network protocol analyzer Ethereal (www.ethereal.com), complex network analyzer Sniffer from Sniffer Technologies (www.sniffer.com), Sniffer Portable from Network Associates (www.networkassociates.com) or LanPro network analyzer from Radcom (www.radcom.com). Most sniffing type products can combine collected packets into application-related flows. VF/VSF level capabilities of sniffer/data analyzers are mostly used for protocol decoding and application level statistics of some VFs calculated off-line. Although being very useful tools, the devices are inferior in their capability to present near real-time flow related parameters (e.g. throughput, number of packets per second) for all virtual flows running in the network. Some information about the network may be learned from QoS boxes (e.g. manufactured by Packeteer, Allot, etc.) or routers with QoS capabilities (Cisco), deployed as the gateway devices to the outside Internet and providing a lot of useful information about the traffic passed through them, whereas all other LAN flows remain completely “invisible”. The effectiveness of QoS box deployment may be improved and sometimes even becomes unnecessary, if flow visualization of networks, including historical data, could be available for detailed analyses of network events.

Systems, devices and methods, disclosed in U.S. Pat. Nos. 6,108,782, 6,453,345, 6,459,682, 6,615,262, 6,661,778, EP 1341345, U.S. patent application 2001/0021176, 2002/0032717, 2003/0055950, and WO 01/71545, 02/21802, WO 02/33892 failed to provide detailed data for each individual virtual flow, especially retransmission data, RTT, server response delay, reasons for VFs completions (e.g whether server or client is timed out, server-side or client side initiated disconnect, etc.), changes in throughput and other flow-statistics counters within a flow lifetime and other important for network engineers information. Computer system and method disclosed in U.S. Pat. No. 6,453,345 is based on a permanent storage of packets running in networks to provide current and historical aspects of network statistics, which requires sophisticated storage devices. All mentioned prior art has failed to provide inexpensive and, therefore, affordable solution for most companies for configurable presentation of the whole network picture in a near real-time and does not teach how to obtain detailed information necessary for networks troubleshooting and optimization, detection of anomalies and a time-sampled historical searchable view on the total network as well as on each individual VF, VSF, AGVF or any other logical flow.

Network administrators and engineers lack instrumentation to “watch” what is currently running in their networks to perform in-depth analyses of the traffic, networks performance optimization and troubleshooting, to reveal network anomalies and to obtain historical information about the traffic, e.g. in the last hour, night, or a time period between certain dates, or at the date and time of an important sometimes disastrous event in the network.

It is the object of the present invention to provide a method and computer system able to supply a network administrator or engineer with near real-time information/statistics as well as with historical data relating to all virtual flows running in the network and also derived information regarding various logical flows in the network.

### DISCLOSURE OF INVENTION

An aspect of the present invention, is a computer system, deployed as a passive network device, which monitors LAN/WAN traffic without being physically on packet routes, collects and processes valid packets from the network, retrieves statistical information from the packets, assembles and maps the information to a VF-statistics, stores said information in a searchable database and outputs VF-statistics and the derived OSI layer-2 and layer-3 addresses, network-devices, OSI levels 3, 4, 5, 6 protocols, OSI level-7 applications and aggregate-virtual-flow based statistics to a near-real time GUI presentation.

Yet another aspect of the invention is deployment of the computer system physically on the packet routes (active deployment), enabling it not only to collect statistical information, store it to a database and analyze the traffic, but also to apply results of the analyses actively by performing traffic modifications, e.g. by dropping a worm related VFs to prevent the worm spreading.

Another aspect of the present invention is a co-hosting the invented system on the same computer and the same NIC (and normal functioning) with other network tools such as sniffers, firewalls, QoS and IDS systems. It is worth to mention that the invention enables passive deployment of the invented system with the above-mentioned network tools without limitations, whereas the active deployment of the system encompassing active network tools like firewalls, QoS and IDS may cause limitations or require coordination of performance activities between the invented system and the tools.

Another aspect of the present invention relates to further processing VF-based information into the application, network protocols and host related information, by making application/protocols classification of all VFs in the network, whereas the destination/source address of each host (IP-address in ip-networks) is an integral part of VFID. Keeping all VF data, including VFID and statistics counters, in a searchable database enables an easy access to any application, network protocol or host based statistics. According to this aspect of the invention a topology of the networks, from which the system collects statistics, may be reconstructed using IP-addresses of all hosts, stored per each VF in the database, and either netmask inputs from network administrators, or netmask discovery techniques. A network topology map resulting from the reconstruction is a useful and convenient GUI, which in combination with the capability of the invented system to depict on the map in near real-time statistics regarding applications, protocols, throughputs, retransmissions, RTT (Round-Trip Time), numbers of connections and packets, other parameters with relation to network elements and their interconnections, creates real visualization of network dynamics. The invented system provides a network administrator or an engineer with the means necessary for real control of network, enables bottleneck analyses and troubleshooting, re-planning and network layout optimization.

It is yet another aspect of the present invention providing an analytical agent, which is capable of revealing network bottlenecks and/or network poor performance and of triggering relevant recommendations for network optimization. Statistical information regarding all VFs running in the network is collected for each time sampling period, which is normally configurable from seconds to tens of seconds. Data for each VF, which represents a collection of statistics for at least one time sampling period, is kept by the system long enough enabling historical searches. Thus, an administrator may easily obtain time-dependent throughput data for a very important long running VF including times when there was insufficient bandwidth. It is easy to figure out the sources and reasons of extra retransmissions, to locate the most bandwidth-consuming hosts and applications at peak hours and to gain deep understanding of the nature of the load on a web-server at different hours, etc.

A one more aspect of the present invention relates to processing of VF-based information to the aggregate-virtual-flows (AGVFs) information by combining VFs with a certain common parameter (e.g. by combining VFs with a source or destination IP being related to a certain subnet), thereby providing a subnet-level visualization of the traffic and network events. It may be extremely useful for network personnel to keep track of a AGVF, combining VFs by a certain common type of service or functionality. For example, it may be useful in networks served by several Internet providers to monitor the SLA per each provider by arranging AGVF per provider. Another possible application of the aspect of the invention is monitoring traffic from a company central office to its affiliated premises by configuring an AGVF for each remote office.

Yet another aspect of the invention is an availability control of network elements and network services. Absence of VFs, originating from a certain network element (NE) and/or broken VFs full of retransmissions towards the NE, trigger configurable NE availability alerts. It may be easily configured to monitor availability of a certain type of applications/services, running on a NE or on a group of NE to trigger alerts when the applications/services are malfunctioning.

Another aspect of the present invention relates to a time-sampled storage of statistical information regarding each individual VF in a searchable database. Once in a configurable amount of time VF-based and derived (OSI layer-2 and layer-3 addresses, network-devices, OSI levels 3, 4, 5, 6 protocols, OSI level-7 applications and aggregate-virtual-flow based) statistical information is summarized and stored in a database, so that for all sessions with a lifetime more than a sampling time, a historical view on each statistics counter may be retrieved to provide graphs and tables of parameters (e.g throughput, retransmissions, RTT, etc). Such historical view can, for example, reveal throughput starvation for an important VF at certain hours to be remedied by re-scheduling of the less important traffic from the peek hours or changing QoS-related policies in a router/QoS-box or by any other means. Various configurable searches in the database may provide a crucial information for network engineers and administrators by highlighting applications and hosts with most bandwidth consumption at peek-hours, network elements with a maximum connections to/from them, reasons for web-server connection requests not being served at certain hours, retransmissions peeks originating from a group of servers at certain hours, etc.

Another aspect of the present invention relates to network security. This is possible to accomplish because all VF-related information is stored in a database or in recoverable to database file storage formats and may be examined. Unusual patterns of behavior, like huge amount of VFs from Internet to a certain computer, normally serving only LAN-residents, or lots of opened connections from a certain machine, will set of the system's alerts and actions configured by administrator.

A one more aspect of the present invention relates to improving network security. Keeping a full VFs history backlog enables to reveal fingerprints (VFs) of an intrusion to a computer in the network, which occurred at a known time in the past. Spreading a worm in the network generates an anomalous flow with a great number of VFs from a worm-sourcing computer to all other NEs. Worm spreading pattern may be alerted, helping to prevent it and/or reveal computer from which the worm spreads. Patterns of DOS/DDOS attacks may be easily highlighted causing an alert for action to be undertaken.

Another aspect of the present invention is a use of the available statistical information for billing purposes, thereby enabling different and more flexible billing methods than the ones cited in prior arts, allowing charging of customers based on the amount of data cleared from retransmission or, interalia, taking some other statistical VF parameters into consideration.

Yet another aspect of the invention is a use of the collected statistical data to monitor QoS conditions in a network, including monitoring SLA (service level agreement) with providers.

### BRIEF DESCRIPTION OF THE DRAWINGS

FIG. 1. is a units diagram of the invention and the flow between units, which illustrates a preferred process;

FIG. 2. illustrates the primarily components of Network Interface Unit (NIU) and the flow of traffic among the NIU components and related units of the system;

FIG. 3. illustrates the primarily components of Information Processing Unit (IPU) and the flow of traffic among the IPU components and related units of the system;

FIG. 4. illustrates the primarily components of Data Presentation and Visualization Unit (DPVU) and the flow of traffic among the DPVU components and related units of the system;

FIG. 5. illustrates the primarily components of Data Storage Unit (DSU) and the flow of traffic among the DSU components and related units of the system;

### BEST MODE FOR CARRYING OUT THE INVENTION

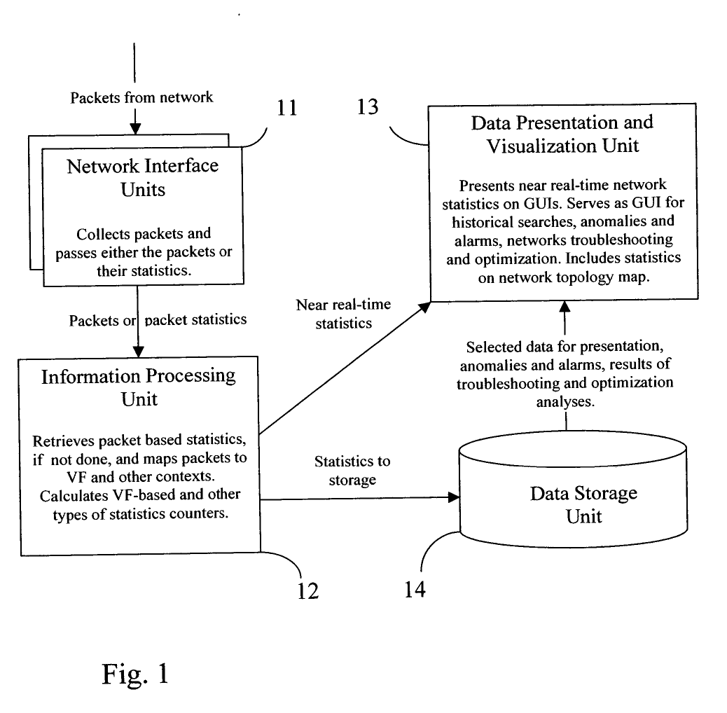

FIG. 1 depicts the flow and unit-level functionalities of the invention. All valid packets of the network are collected by one or several Network Interface Units (NIUs) 11 and passed further as raw packets. Alternatively a packet-based statistics may be collected and passed to an Information Processing Unit (IPU) 12. The IPU 12 performs mapping of packets or packet-based statistics to virtual flows (VFs), calculates packet-based statistics (if not done before) and updates a VF-based statistics as well as other types of statistics, such as application based, IP-based, aggregate-virtual-flow based, etc., according to the configuration of the invented device. The VF-based and other types of statistics are passed to a Data Presentation and Visualization Unit (DPVU) 13 and to a Data Storage Unit (DSU) 14. The DPVU 13 presents on GUI near real-time statistical information, including statistics depicted on the network topology diagram, and provides searchable interface to the data stored in DSU 14. The DSU 14 performs storage and search of statistical information.

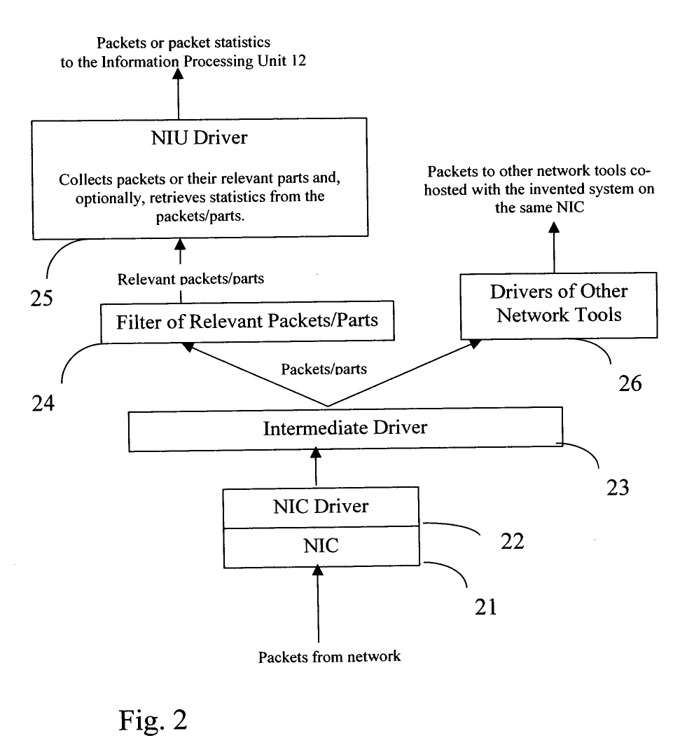

FIG. 2 illustrates the components of NIU 11, the traffic and the relationship between the components and other units. In some embodiments, when the system is deployed passively not being on the path of the packets, NICs 21 are in a promiscuous mode connected either directly to the network or to a mirroring port of a switching device. Each NIC 21 receives all datalink frames (further packets) in the network and passes the packets to a NIC Driver 22. In other embodiments, when the system is deployed actively (e.g. being a part of a QoS box, processing and queuing packets) the systems gets the packets or copies of the packets from the module of the active system performing packets fetching by any suitable means.

In some embodiments the NUI 11 deploys an Intermediate Driver 23 to be inserted between NIC Driver 22 and TCP/IP stack. The Intermediate Driver 23 provides TCP/IP-like interface towards NIC Driver 22 and NIC-driver-like interface towards NIU Driver 25 and/or Drivers of Other Network Tools 26 such as sniffers, firewalls, QoS and IDS systems. The Intermediate Driver 23 intercepts packets on the path from NIC Driver 22 to TCP/IP stack and acts to ensure delivery of a copy of each packet to the NUI Driver 25 as well as to the Drivers of Other Network Tools 26. Intermediate Driver 23 enables co-hosting on the same NIC and independent proper functioning of the invented system and the other network tools. In some other embodiments the NUI Driver 25 itself accomplishes the functions of the Intermediate Driver.

In some embodiments the packets collected by NIUs 11 are passed through a configurable Filter 24 with rules enabling further treatment of only relevant packets to/from certain IP addresses, networks, ports or selected by any other configurable parameters. The Filter 24 is configured and activated, when it is required to limit the amount of incoming packets and statistics information, e.g. to decrease load on the system by collecting, processing, presenting and storing only the information of interest, thereby filtering an irrelevant traffic.

In other embodiments, when the invented system is deployed in a passive mode, all packets (or only filtered ones) are processed in the NIU Driver 25 used by the system to retrieve relevant statistics, which is passed to the IPU 12. In some other embodiments, whenever the system is deployed as active or passive, packets are passed to IPU 12 without filtering.

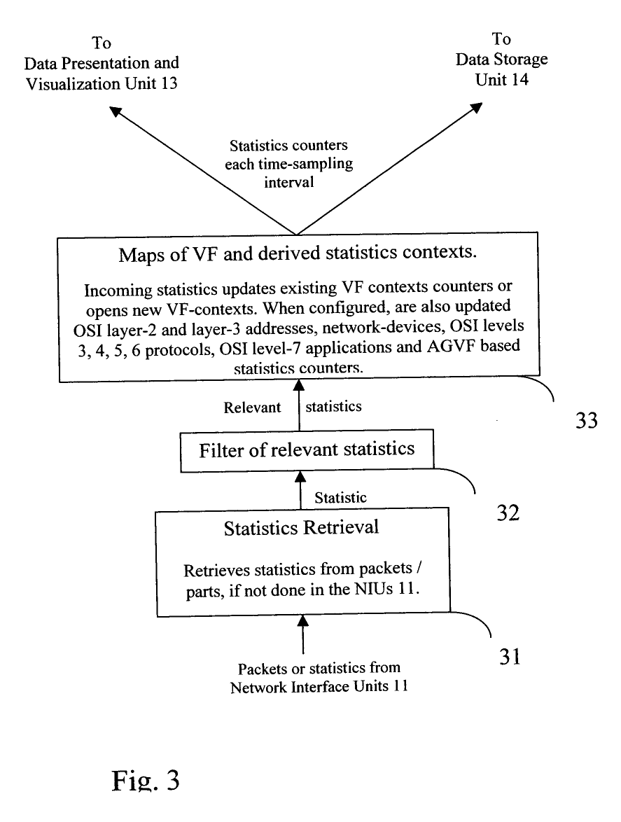

The IPU 12, showed in detail at FIG. 3, receives either datalink packets/parts of packets or packet statistics information from all deployed NIUs 11. When IPU 12 receives packets/parts or packets, it retrieves the statistics in Statistics Retrieval 31 module. The statistics is further optionally filtered by a configurable Filter 32 to pass forward only relevant statistics. The IPU 12 manages a map of virtual flow contexts 33 for all VFs running in the system. The statistics of the first packet of each flow opens a new VF-context, which is uniquely identified by the VF-context key consisting from network layer header information (in the case of IPv4 traffic—IP source and destination addresses, source and destination ports and IP-protocol) and an absolute date-time stamp of the first packet arrival. The VF-context consists of two sub-contexts containing inbound and outbound counters for both directions of the VF to deal with bidirectional flows. Each flow of one a bidirectional VF is called hereafter a sub-flow. The existing VF-contexts are kept in a data structure called VF-context map 33 and available for a fast lookup using a VF-context key. The lookup to the context map is performed for each incoming packet or packet statistics information and, if this information cannot be assigned to an existing VF-context, a new VF-context is created and its statistics counters are updated for the first time. If the incoming packet statistics information is assigned to an existing VF-context, the statistics is used to update counters of the VF-context. For example, a new VF context is opened for TCP/IP VFs on statistics of a first incoming SYN packet (on the system startup with the first VF packet) and is closed either when a TCP-session is closed by FINs and ACKs or RST packets or when a long enough configurable and application dependent timeout expires. For TCP/UDP new context is opened by statistics of the first VF packet and closed on a large enough configurable application dependent timeout. When a VF-context is closed, it will be removed from the system only after its statistics are collected and passed for processing.

In general, the VF-context enables to calculate for each sub-flow the following statistics counters for each time sampling period as well as VF life-time averages: a number of packets passed, packets throughput in second, packets size, a distribution of packet sizes, packets latency and the latency jitter, bytes passed, bytes throughput, average timeout between packets and counters for packets bursting, etc. VF context for TCP/IP traffic additionally enables calculation of retransmitted packets, retransmitted packets throughput in second, retransmitted bytes, retransmitted throughput, effective throughput (throughput cleaned from retransmissions), RTT and RTT jitter. VF context for TCP/IP performs permanent overview of TCP-session in both directions (for each sub-flow), including milliseconds accurate timing for each packet, inspection and analyses of TCP-header packet sequence number and acknowledgment number to follow retransmission and in some cases reasons for retransmissions and to be used for RTT estimations. The retransmission, RTT and TCP header flag bits (RST, SYN, FIN, ACK) information are used to figure out reasons for VFs completions, such as server or client side timeout, server-side or client side initiated disconnect, etc.

If the statistics is collected on the level of AGVFs, each AGVF on configuration arranges an AGVF-context to keep the counters. The first packet for each VF and the first packet from each side of a for bi-directional flows is classified to figure out whether the traffic matches rules configured for any AGVF, and when it does, all packets assigned to the sub-flow will be used to update statistics counters for an appropriate AGVF.

When the configured statistics is collected on the level of applications, a VF is classified by transferring packets to an application classifier. If the VF is recognized to belong to an application of interest, the VF statistics is used to update the counters in the application statistics context. Some of the application-specific parameters may be kept in the VF context to enable a further VSF reconstruction and an advanced analyses of application traffic.

Collection of statistics based on IP addresses is accomplished by arranging a data structure further named a map of IP-contexts, which contains a context per active IP-address in the network with two sub-contexts for inbound and outbound traffic, respectively. Statistics of an IP-context is updated using VFs sources or destined to the IP-address. When the last VF with a certain IP-address is removed from the system, so does the IP-context after its statistics were collected.

On each configurable time-sampling timeout, which is from seconds to tens of seconds, all statistics from all VF-contexts, AGVF-contexts, IP-contexts and application-contexts kept in Maps 33 is summarized, calculated, collected and passed to the DPVU 3 and the DSU 4 units.

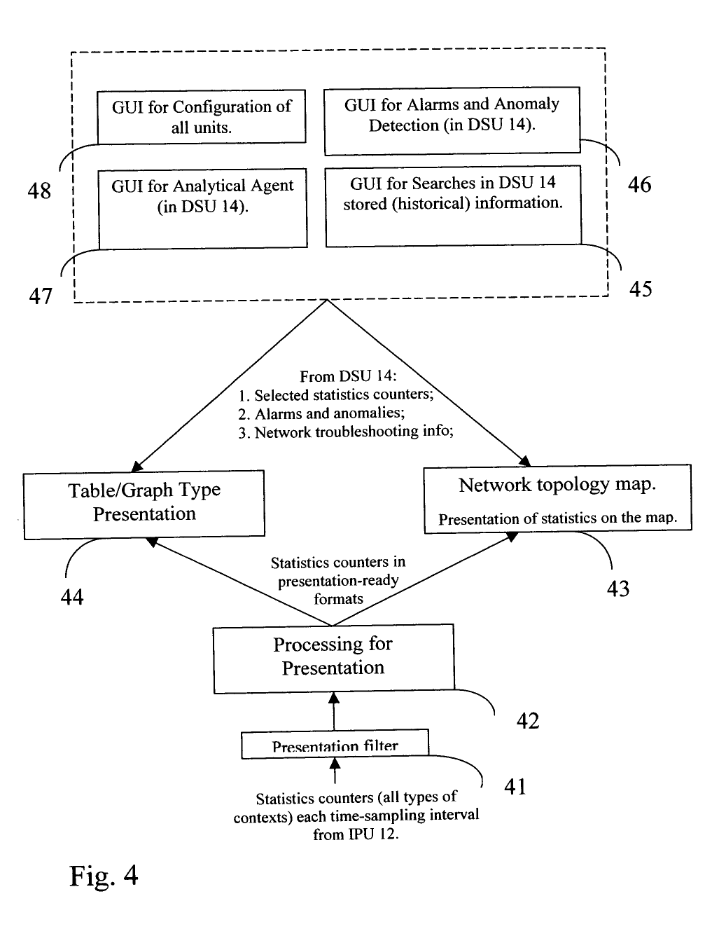

The DPVU 3 is shown in details at FIG. 4. The incoming statistics of all types of contexts is filtered by a configurable Presentation Filter 41 and processed by Processing for Presentation 42 module to convert the data into convenient for presentation formats. The DPVU 3 depicts statistical information at two types of GUI: one of them is a “usual”, Table/Graph Type Presentation 44, while another is the Network Topology Map 43 with presentation of statistics counters. Whereas a presentation of the near real-time statistics on the Table/Graph Type Presentation 44 GUI is rather straightforward, creation and update of the statistics presentation at the Network Topology Map 43 require further processing of the IP-contexts, containing all currently active in the system IP-addresses. Network topology reconstruction techniques are used to create and update the map of NEs, whereas the configurable statistics counters are presented on the map for each NE of interest. The DPVU contains also GUI for Searches 45 in DSU 4 stored historical statistics, GUI for Alarms and Anomalies Detection 46 (in DSU 4), GUI for Analytical Agent 47 (in DSU 4), and GUI for Configurations 48.

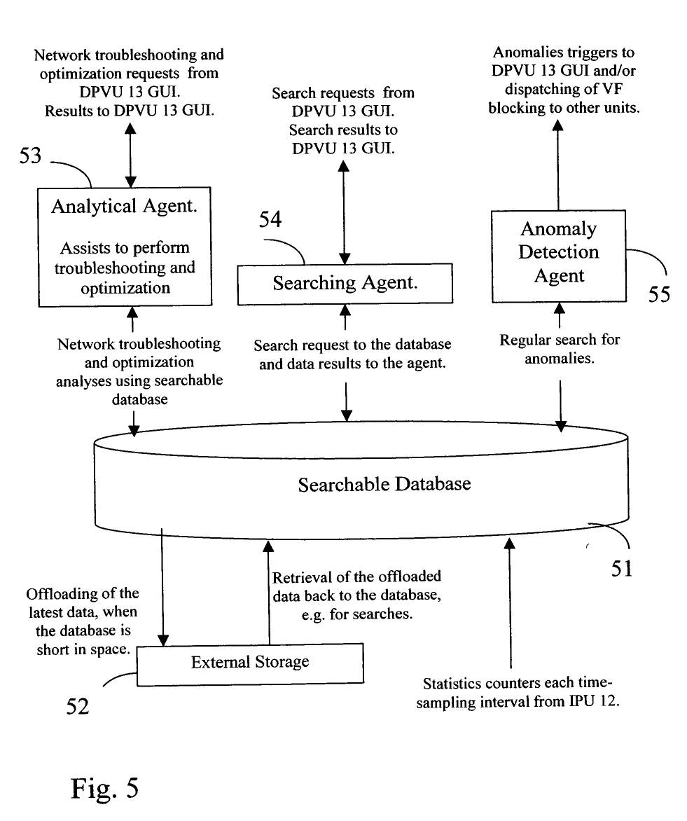

The DSU 4, detailed at FIG. 5, in preferred embodiments of the invention stores the statistics of all types in a Searchable Database 51. A searching Agent 54 (with a GUI for Searches 45) serves to perform searches for VF, AGVF, IP and application statistics based information in the most recent data as well as in the historical statistics, stored in the Searchable Database 51. In some embodiments, when the Searchable Database 51 lacks space, an outdated data is offloaded to External Storage 52 with an option to be retrieved back to the said database, when required. The DSU 4 may be configured to perform VSFs reconstruction based on application-specific parameters, kept on the level of VFs and application flows information. The DSU 4, when configured, runs a configurable Anomaly Detection Agent 55 to perform traversing the stored statistics in order to reveal unusual patterns and sends alarms and events via an GUI for Alarms and Anomaly Detection 46, as well as via configurable messaging channels like e-mails, SMS, phone notifications, etc. When the system is deployed as an active, being on the packets path (e.g. as a part of in-path QoS box), the Anomaly Detection Agent 55 will dispatch blocking of damaging VFs recognized as a threat. The DSU 4 contains also an Analytical Agent 53 to assist the users of the system in troubleshooting and network optimization with a data output to the GUI for Analytical Agent 47.

### INDUSTRIAL APPLICABILITY

The invention may be used by network engineers and administrators as a tool for a near real-time control of network traffic, as an analytical tool for solving network bottlenecks, network performance optimization and troubleshooting analyses, cutting costs by optimizing network layout, appropriate organization of traffic and intelligent configuration of QoS, routers and other network devices.

What is claimed is:

1. A computer system for gathering, processing and analysis of network information resulting in presentation and visualization of packet networks in a time-dependent dynamics, comprising:
at least one network interface unit, containing NIC, which collects all valid data-link network packets (or parts thereof required for gathering the statistics) and, optionally, retrieves virtual flow statistical and identity information from the packets or parts thereof;
at least one information processing unit, which retrieves, (if not done by the network interface units), the virtual flow statistical and identity information from the packets/parts thereof, maps and processes the information each time-sampling interval into any configurable combination of statistics counters chosen from virtual flow, OSI layer-2 and layer-3 address, network devices, OSI levels 3, 4, 5 and 6 protocol, OSI level-7 application and aggregate-virtual-flow based counters;
at least one data presentation and visualization unit to convert the said statistics into appropriate data and graphical formats useful for a customer, and to provide GUI for a near-real time presentation as well as for results of historical searches, alerts and analytical processing;
at least one data storage unit which records each time-sampling interval the chosen configurable combination (in the information processing unit) of statistics counters into searchable files or databases, and enables network troubleshooting, optimization analyses and detection of anomalies.

2. The computer system as defined in claim 1, wherein an intermediate driver is deployed between the NIC driver and the network interface unit driver to enable normal parallel functioning of the computer system with other network tools (such as sniffers, firewalls and IDS-engines), when co-hosted on the same NIC.

3. The computer system as defined in claim 1, wherein the network interface unit and the information processing unit are configured to filter the incoming packets or their parts according to the configurable filter rules, keeping the packets or parts thereof in a memory and/or temporary logging (onto a non-volatile storage) only those areas of the packets/parts that are necessary for further analysis.

4. The computer system as defined in claim 1, wherein each unit of the system contains a configurable filter, enabling to gather, combine, process and display only the necessary information, thereby reducing a load on the system.

5. The computer system as defined in claim 1, wherein said information processing, data presentation and visualization units are configured to provide statistics based on groups of network-devices, combined into an aggregate-virtual-flow statistics by their source or/and destination addresses or particular subnets.

6. The computer system as defined in claim 1, wherein said information processing, data presentation and visualization units are configured to provide aggregate-virtual-flow statistics, combining data from all VFs with any common configurable parameter or a group thereof.

7. The computer system as defined in claim 1, wherein said data presentation and visualization unit is configured to reconstruct a full network topology map, using collected OSI layer-2 and layer-3 addresses, with subsequent presentation on the map of any configurable combination of statistics counters chosen from virtual, OSI layer-2 and layer-3 address, network-devices, OSI levels 3, 4, 5 and 6 protocol, OSI level-7 application and aggregate-virtual-flow based counters.

8. The computer system as defined in claim 1, wherein said information processing, data presentation and visualization and data storage units are configured to reveal network anomalies and dispatch respective triggers.

9. The computer system as defined in claim 1, wherein said information network interface, processing, and data storage units are configured to screen the gathered packets or their parts and/or virtual flow counters to discover signatures of viruses, worms, intrusion attempts or DOS/DDOS attacks and to trigger notification and/or dispatch blocking the virtual flows with malicious traffic.

10. The computer system as defined in claim 1, further comprises an analytical agent, capable of revealing network bottlenecks and/or network poor performance and suggesting relevant recommendations for network engineers and administrators.

11. The computer system as defined in claim 1, wherein said data presentation and visualization and data storage units are configured to screen the collected virtual flows in order to reveal patterns of worm spreading, intrusion attempts or DOS/DDOS attacks, and to inform network administrators and/or to dispatch blocking the virtual flows with malicious traffic.

12. A use of the computer system defined in claim 1, for billing purposes.

13. A use of the computer system defined in claim 1 for monitoring QoS conditions in the network, including SLAs with providers.

14. The computer system as defined in claim 1, wherein for generating a unique database key, when storing virtual flow based statistics into a database or in any other non-volatile storage, are used date and time of the virtual flow start (i.e., date and time of the first captured packet in the VF) with a resolution of at least in seconds in a combination with the virtual flow identity parameters; wherein said combination ensures uniqueness of the key.

15. A method for visualization of a plurality of communication networks, comprising:
gathering the virtual flow statistical and identity information from all datalink packets in the network or relevant parts of these packets;
mapping and processing said information each time-sampling interval into any configurable combination of statistics counters chosen from virtual flow, OSI layer-2 and layer-3 address, network devices, OSI levels 3, 4, 5 and 6 protocol, OSI level-7 application and aggregate-virtual-flow based counters;
near-real time presentation of said statistics in its time sampled dynamics in a data and graphical formats useful for a customer;
recording each time-sampling interval the configured (on the stage of information mapping and processing) combination of statistics counters into searchable files or databases, and proceeding with network troubleshooting, optimization analyses and detection of anomalies;
filtering only relevant information at each of the above-mentioned stages;
temporary storage of the necessary parts of datalink packets and their further analysis, e.g. for suspected traffic;
detailed processing of the collected historical statistics in order to reveal anomalies and to dispatch appropriate triggers;
screening the gathered packets or their parts and/or virtual flow statistics to discover signatures of viruses, worms, intrusion attempts or DOS/DDOS attacks and to trigger notifications and/or dispatch blocking the virtual flows with malicious traffic;
detailed processing of the collected historical statistics to reveal network bottlenecks and/or network poor performance and to trigger relevant recommendations for network engineers and administrators;

16. The method as defined in claim 15, wherein gathering of virtual flow statistical and identity information from datalink packets in the networks or relevant parts of these packets can be parallel and independent from the co-hosted on the same NIC other network tools (such as sniffers, firewalls and IDS-engines), wherein said method is implemented by deployment of the intermediate driver.

17. The method as defined in claim 15, wherein the statistics of ISO layer-2 and layer-3 addresses is used to reconstruct a full network topology map, using the collected OSI layer-2 and layer-3 addresses, including further presentation on the map of any configurable combination of statistics counters chosen from virtual flow, OSI layer-2 and layer-3 addresses, network-devices, OSI levels 3, 4, 5 and 6 protocol, OSI level-7 application and aggregate-virtual-flow based statistics counters.

18. The method as defined in claim 15, wherein for generating a unique database key, when storing virtual flow based statistics into a database or onto any other non-volatile storage, uses date and time with a resolution, at least in seconds, of the virtual flow start (date and time of the first packet in VF) in combination with virtual flow identity parameters; wherein said combination ensures uniqueness of the key.
